(19) United States
(12) Patent Application Publication
(10) Pub. No.: US 2004/0227090 A1
(43) Pub. Date: Nov. 18, 2004

(54) Dosimetry system

(75) Inventor: Satoshi Arakawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/843,621

(22) Filed: May 12, 2004

(30) Foreign Application Priority Data
May 15, 2003 (JP) 137165/2003

(51) Int. Cl. G01T 1/164

(52) U.S. Cl. 250/363.02; 378/97

(57) ABSTRACT

A radiation image recording medium is exposed to radiation passing through an object to record a radiation image of the object carried by the radiation. A heavy-element-containing phosphor sheet which is formed by heavy-element-containing phosphors containing therein a heavy element to emit light in an amount corresponding to the dose of radiation irradiated thereto is opposed to the radiation image recording medium on the side opposite to the object. A detector detects light emitted from the heavy-element-containing phosphor sheet.

### BACKGROUND OF THE INVENTION

1. Field of the Invention

This invention relates to a dosimetry system which detects the dose of radiation when the radiation passing through an object is recorded as a radiation image on a radiation image recording medium.

2. Description of the Related Art

There have been put into practice and proposed in taking medical radiation images various types of radiation image recording media on which radiation such as an X-ray passing through an object is recorded as a radiation image.

As the radiation image recording medium, there have been known, for instance, a stimulable phosphor sheet comprising a layer of stimulable phosphors which store a part of radiation energy upon exposure to radiation and emit, upon exposure to stimulating light such as visible light or a laser beam, stimulated emission in proportion to radiation energy stored therein, or a recording medium which generates electric charges in proportion to the dose of radiation irradiated thereto and stores the electric charges as a latent image charge. The term “dose” as used here means the amount of radiation energy absorbed by unit mass of the material exposed to radiation, or a value proportional to the amount of radiation energy.

When a radiation image is to be taken by the use of such a radiation image recording medium, the dose of radiation is controlled on the basis of the site of the human body an image of which is to be taken and/or the kind of the radiation source. It is necessary for the dose of the radiation to be an amount which does not adversely affect the human body and at the same time, provides radiation image quality suitable for diagnosis. As a method of controlling the dose of radiation, a method which controls the dose of radiation by the use of a photo-timer is proposed in Japanese Unexamined Patent Publication No. 8(1996)-62748. This method is based on the use of a photo-timer comprising a dosimetry phosphor sheet which instantaneously emits light upon exposure to radiation, a photodetector which detects light instantaneously emitted from the dosimetry phosphor sheet and a control means which controls the dose of the radiation on the basis of the level of the instantaneous light detected by the photodetector so that the dosimetry phosphor sheet is disposed between the object and the radiation image recording medium, exposing the dosimetry phosphor sheet to the radiation passing through the object, and the dose of the radiation is controlled on the basis of the detected level of the instantaneous light emitted from the dosimetry phosphor sheet.

However, the method proposed in Japanese Unexamined Patent Publication No. 8(1996)-62748 is disadvantageous in that since a part of the radiation energy is absorbed by the dosimetry phosphor sheet disposed between the object and the radiation image recording medium, the dose of the radiation irradiated to the radiation image recording medium deteriorates and scattering radiation generated by irradiation of the radiation onto the dosimetry phosphor sheet impinges upon the radiation image recording medium to deteriorate the contrast of the radiation image recorded on the radiation image recording medium.

Though absorption of the radiation energy by the dosimetry phosphor sheet can be avoided by disposing the dosimetry phosphor sheet on the side of the radiation image recording medium remoter from the object so that the dosimetry phosphor sheet is exposed to the radiation passing through the radiation image recording medium, this approach cannot avoid impingement upon the radiation image recording medium of the scattered radiation from the dosimetry phosphor sheet.

Further, it has been known that not only the scattered radiation from the dosimetry phosphor sheet but also scattered radiation from casings and the like can impinge upon the rear side (the side remoter from the object as compared with the other side) of the radiation image recording medium to deteriorate the quality of the radiation image recorded on the radiation image recording medium.

### SUMMARY OF THE INVENTION

In view of the foregoing observations and description, the primary object of the present invention is to provide a dosimetry system which can detect the dose of radiation for adequate control of the amount of the radiation when taking a radiation image by the use of the radiation image recording medium described above without deterioration of the radiation image recorded on the radiation image recording medium due to the scattered radiation described above.

In accordance with the present invention, there is provided a first dosimetry system comprising a heavy-element-containing phosphor sheet which is formed by heavy-element-containing phosphors containing therein a heavy element to emit light in an amount corresponding to the dose of radiation irradiated thereto and is opposed to a radiation image recording medium, which is exposed to radiation passing through an object to record a radiation image of the object carried by the radiation, on the side opposite to the object, and a detecting means which detects light emitted from the heavy-element-containing phosphor sheet.

In accordance with the present invention, there is provided a second dosimetry system comprising a phosphor sheet which is formed by phosphors to emit light in an amount corresponding to the dose of radiation irradiated thereto and is opposed to a radiation image recording medium, which is exposed to radiation passing through an object to record a radiation image of the object carried by the radiation, on the side opposite to the object, a heavy-element-containing light guide means which is formed by material containing therein a heavy element and guides light emitted from the phosphor sheet, and a detecting means which detects light guided by the heavy-element-containing light guide means.

In accordance with the present invention, there is provided a third dosimetry system comprising a heavy-element-containing phosphor sheet which is formed by heavy-element-containing phosphors containing therein a heavy element to emit light in an amount corresponding to the dose of radiation irradiated thereto and is opposed to a radiation image recording medium, which is exposed to radiation passing through an object to record a radiation image of the object carried by the radiation, on the side opposite to the object, a light guide means which transmits light emitted from the heavy-element-containing phosphor sheet, reflects the transmitted light by a reflecting portion provided for the whole or a part of the light exit face through which the light emitted from the heavy-element-containing phosphor sheet exits and guides the reflected light, and a detecting means which detects light guided by the light guide means.

In accordance with the present invention, there is provided a fourth dosimetry system comprising a phosphor sheet which is formed by phosphors to emit light in an amount corresponding to the dose of radiation irradiated thereto and is opposed to a radiation image recording medium, which is exposed to radiation passing through an object to record a radiation image of the object carried by the radiation, on the side opposite to the object, a heavy-element-containing light guide means which is formed by material containing therein a heavy element, transmits light emitted from the phosphor sheet, reflects the transmitted light by a reflecting portion provided for the whole or a part of the light exit face through which the light emitted from the phosphor sheet exits and guides the reflected light, and a detecting means which detects light guided by the heavy-element-containing light guide means.

The term “heavy element” as used here means one of the elements included in and after the sixth period of the periodic table including lanthanoids. The “heavy-element-containing phosphor” may be any phosphor so long as it emits fluorescence upon exposure to radiation and it contains a heavy element which absorbs scattering radiation. For example, the heavy-element-containing phosphor may be CaWO₄, BaFX:Eu (X stands for Cl, Br or I), or Gd₂O₂S:Tb.

The term “material containing therein a heavy element” means may be any material so long as it guides the light emitted from the phosphor sheet and it contains a heavy element which absorbs scattering radiation. For example, the material containing therein a heavy element may be lead-containing glass, lead-containing acrylic resin or rare earth glass.

In the first dosimetry system of the present invention, a heavy-element-containing phosphor sheet which is formed by heavy-element-containing phosphors containing therein a heavy element and emits light in an amount corresponding to the dose of radiation irradiated thereto is opposed to the radiation image recording medium on the side opposite to the object. Accordingly, the radiation energy irradiated to the radiation image recording medium is not attenuated and at the same time, scattering light from the phosphor sheet and the like is absorbed by the heavy element, whereby the dose of the radiation passing through the object can be detected as the amount of light emitted from the phosphor sheet without deteriorating the quality of the image recorded on the radiation image recording medium.

In the second dosimetry system of the present invention, a phosphor sheet which is formed by phosphors and emits light in an amount corresponding to the dose of radiation irradiated thereto is opposed to a radiation image recording medium on the side opposite to the object, and light emitted from the phosphor sheet is guided by a heavy-element-containing light guide means which is formed by material containing therein a heavy element. Accordingly, the radiation energy irradiated to the radiation image recording medium is not attenuated and at the same time, scattering light from the phosphor sheet and the like is absorbed by the heavy element of the heavy-element-containing light guide means, whereby the dose of the radiation passing through the object can be detected as the amount of light emitted from the phosphor sheet without deteriorating the quality of the image recorded on the radiation image recording medium.

In the third dosimetry system of the present invention, a heavy-element-containing phosphor sheet which is formed by heavy-element-containing phosphors containing therein a heavy element and emits light in an amount corresponding to the dose of radiation irradiated thereto is opposed to a radiation image recording medium on the side opposite to the object. Accordingly, the radiation energy irradiated to the radiation image recording medium is not attenuated and at the same time, scattering light from the phosphor sheet and the like is absorbed by the heavy element, whereby the dose of the radiation passing through the object can be detected as the amount of light emitted from the phosphor sheet without deteriorating the quality of the image recorded on the radiation image recording medium as in the first dosimetry system of the present invention. Further, when the heavy-element-containing phosphor sheet and the light guide means are provided to be opposed to the whole of the radiation image recording medium, light emitted from the heavy-element-containing phosphor sheet is reflected by a reflecting portion provided for a desired part of the light guide means and the reflected light is guided to the detecting means, only the dose of radiation over a desired area can be detected while scattering radiation can be absorbed over the whole area of the radiation image recording medium.

In the fourth dosimetry system of the present invention, a phosphor sheet which is formed by phosphors and emits light in an amount corresponding to the dose of radiation irradiated thereto is opposed to a radiation image recording medium on the side opposite to the object, and light emitted from the phosphor sheet is guided by a heavy-element-containing light guide means which is formed by material containing therein a heavy element. Accordingly, the radiation energy irradiated to the radiation image recording medium is not attenuated and at the same time, scattering light from the light guide means is absorbed by the heavy element in the heavy-element-containing light guide means, whereby the dose of the radiation passing through the object can be detected as the amount of light emitted from the phosphor sheet without deteriorating the quality of the image recorded on the radiation image recording medium as in the second dosimetry system of the present invention. Further, when the heavy-element-containing phosphor sheet and the light guide means are provided to be opposed to the whole of the radiation image recording medium, light emitted from the heavy-element-containing phosphor sheet is reflected by a reflecting portion provided for a desired part of the light guide means and the reflected light is guided to the detecting means, only the dose of radiation over a desired area can be detected while scattering radiation can be absorbed over the whole area of the radiation image recording medium.

### BRIEF DESCRIPTION OF THE DRAWINGS

FIG. 1 is a schematic view showing a radiation image recording apparatus employing a dosimetry system in accordance with an embodiment of the present invention,

FIG. 2 is a view showing in detail the dosimetry system of the radiation image recording apparatus shown in FIG. 1,

FIG. 3 is a view showing another embodiment of the dosimetry system,

FIG. 4 is a view showing still another embodiment of the dosimetry system, and

FIG. 5 is a view showing yet still another embodiment of the dosimetry system.

### DESCRIPTION OF THE PREFERRED EMBODIMENTS

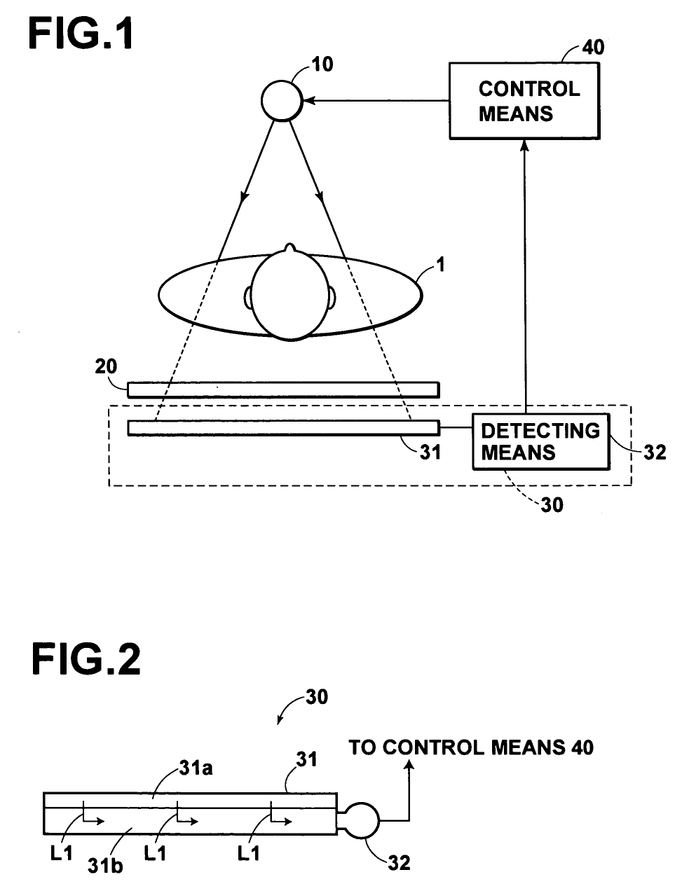

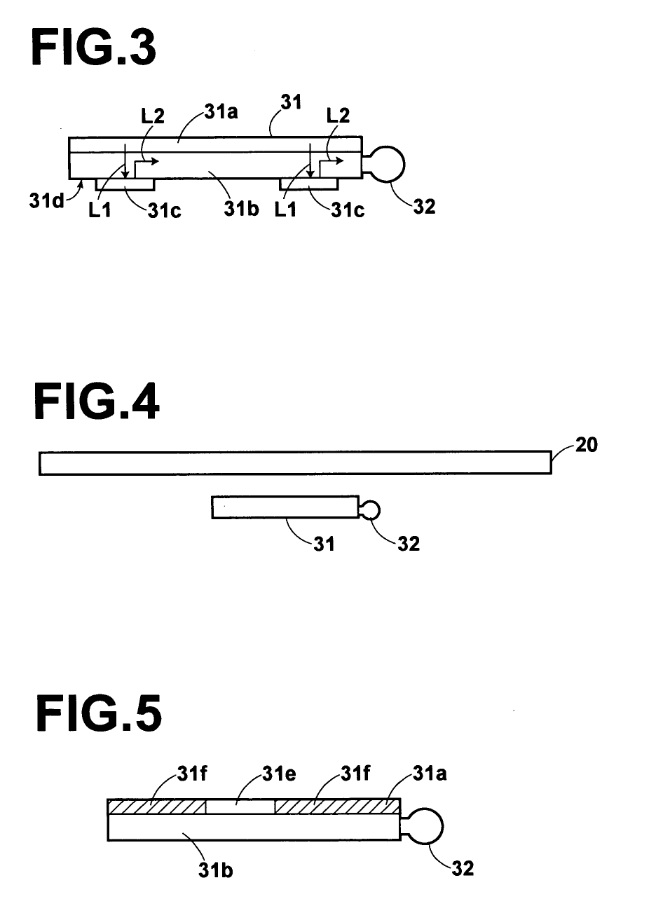

A radiation image recording apparatus employing a dosimetry system in accordance with an embodiment of the present invention will be described with reference to the drawings, hereinbelow. FIG. 1 shows a brief arrangement of a radiation image recording apparatus.

As shown in FIG. 1, the radiation image recording apparatus comprises a radiation source 10, a radiation image recording medium 20 which is exposed to radiation emitted from the radiation source 10 and passed through an object 1 and on which a radiation image represented by radiation passed through the object 1 is recorded, a radiation dose detecting system 30 which detects the amount of radiation passing through the object 1 and the radiation image recording medium 20, and a control means 40 which controls emission of radiation from the radiation source 10 on the basis of the amount of radiation detected by the radiation dose detecting system 30.

In this particular embodiment, the radiation image recording medium 20 is a stimulable phosphor sheet which stores radiation energy upon exposure to radiation and emits stimulated emission in proportion to radiation energy stored therein upon exposure to stimulating light.

The radiation dose detecting system 30 comprises, as shown in FIG. 1, a phosphor sheet system 31 and a detecting means 32. The phosphor sheet system 31 comprises, as shown in FIG. 2, a phosphor sheet 31a which emits light upon exposure to radiation and a light guide means 31b which guides light emitted from the phosphor sheet 31a to the detecting means 32 and is optically in contact with the phosphor sheet 31a. That is, light L1 emitted from the phosphor sheet 31a is led to the detecting means 32 by the light guide means 31b.

The phosphor sheet 31a is a sheet of material containing therein a heavy element phosphors. The heavy element phosphors may be, for instance, CaWO₄, BaFX:Eu (X stands for Cl, Br or I), or Gd₂O₂S:Tb. The light guide means 31b is formed of material containing therein a heavy element and the material containing therein a heavy element may be, for instance, lead-containing glass, lead-containing acrylic resin or rare earth glass.

The detecting means 32 may be, for instance, a photomultiplier which converts light guided by the light guide means 31b into an electric signal.

The control means 40 outputs a control signal to interrupt emission of radiation from the radiation source 10 when the integrated value of the electric signal output from the detecting means 32 exceeds a predetermined threshold value. The threshold value has been determined in advance so that radiation is irradiated to the radiation image recording medium 20 in an amount which does not adversely affect the human body and at the same time, causes the radiation image recording medium 20 to emit sufficient stimulated emission.

Operation of the radiation image recording apparatus will be described, hereinbelow.

Radiation is emitted from the radiation source 10 and irradiated to the object 1. The radiation irradiated to the object 1 passes through the object 1 and radiation carrying thereon a radiation image of the object 1 is irradiated to the radiation image recording medium 20. The radiation irradiated to the radiation image recording medium 20 is partly stored in the radiation image recording medium 20 as radiation representing a radiation image of the object 1 and the other part of the radiation passes through the radiation image recording medium 20 and impinges upon the phosphor sheet 31a of the radiation dose detecting system 30. Upon exposure to radiation, the phosphor sheet 31a emits light in an amount corresponding to the dose of the radiation irradiated thereto. Then as shown in FIG. 2, the light L1 emitted from the phosphor sheet 31a is introduced into the light guide means 31b and guided to the detecting means 32 by the light guide means 31b. Then the light L1 is photoelectrically converted into an electric signal by the detecting means 32 and the electric signal is input into the control means 40. The control means 40 integrates the input electric signal, and when the integrated value of the electric signal becomes larger than the predetermined threshold value, outputs a control signal to interrupt emission of radiation from the radiation source 10. The radiation source 10 stops emission of the radiation upon receipt of the control signal.

When a radiation image is recorded in this manner, a part of the radiation impinging upon the dosimetry system 30 passing through the radiation image recording medium 20 becomes scattering radiation and impinges upon the radiation image recording medium 20 from the rear side thereof, thereby deteriorating the contrast of the radiation image recorded on the radiation image recording medium 20 and/or generating an artifact on the radiation image recorded on the radiation image recording medium 20. In the dosimetry system 30 of this particular embodiment, the heavy elements contained in the phosphor sheet 31a and the light guide means 31b absorb the scattering radiation, whereby the problem described above can be avoided.

Though, in the embodiment described above, both the phosphor sheet 31a and the light guide means 31b contains the heavy element, only one of them may contain the heavy element.

Though, in this particular embodiment, the phosphor sheet 31a and the light guide means 31b of the phosphor sheet system 31 are in optical contact with each other and the light emitted from the phosphor sheet 31a is guided to the detecting means 32, the phosphor sheet 31a and the light guide means 31b of the phosphor sheet system 31 may be out of optical contact with each other so that the light L1 emitted from the phosphor sheet 31a passes through the light guide means 31b, and the light L2 from a reflecting plate 31c provided to oppose a part of the light exit face 31d of the light guide means 31b, through which the light emitted from the phosphor sheet 31a exits, in optical contact with the light guide means 31b to reflect the light L1 passing through the light guide means 31b reenters the light guide member 31b and is guided by the light guide means 31b to the detecting means 32. By providing the reflecting plate 31c only for a part of the light exit face of the light guide means 31b, the dose of the radiation only in desired area can be selectively detected. The reflecting plate 31c may be provided to oppose the whole of the light exit face 31d of the light guide means 31b.

The dosimetry system 30 need not be equivalent in size to the radiation image recording medium 20 as in the embodiment described above, but may be of a size only corresponding to a part of the radiation image recording medium 20 as shown in FIG. 4.

Further, it is not necessary to form the whole phosphor sheet 31a by material containing therein heavy-element-containing phosphors as in the embodiment described above, but only a part 31e of the phosphor sheet 31a may be formed by material containing therein heavy-element-containing phosphors with the other part 31f formed by heavy metal or the like as shown in FIG. 5.

Further, though in the embodiment described above, the stimulable phosphor sheet is employed as the radiation image recording medium 20, the radiation image recording medium 20 may be any so long as it can record the irradiated radiation as a radiation image. For example, the radiation image recording medium 20 may be a recording medium which generates electric charges in proportion to the dose of radiation irradiated thereto and stores the electric charges as a latent image charge. As such a recording medium, there has been known a radiation image recording medium comprising a first electrode layer permeable to radiation, a recording photoconductive layer which generates electric charges upon exposure to radiation, a charge transfer layer which behaves substantially as an insulating material to the latent image charge and substantially as a conductive material to the transfer charge in opposite polarity to the latent image charge, a reading photoconductive layer which generates electric charges upon exposure to reading light, and a second electrode permeable to the reading light, superposed one on another in this order.

What is claimed is;

1. A dosimetry system comprising
a heavy-element-containing phosphor sheet which is formed by heavy-element-containing phosphors containing therein a heavy element to emit light in an amount corresponding to the dose of radiation irradiated thereto and is opposed to a radiation image recording medium, which is exposed to radiation passing through an object to record a radiation image of the object carried by the radiation, on the side opposite to the object, and
a detecting means which detects light emitted from the heavy-element-containing phosphor sheet.

2. dosimetry system comprising
a phosphor sheet which is formed by phosphors to emit light in an amount corresponding to the dose of radiation irradiated thereto and is opposed to a radiation image recording medium, which is exposed to radiation passing through an object to record a radiation image of the object carried by the radiation, on the side opposite to the object,
a heavy-element-containing light guide means which is formed by material containing therein a heavy element and guides light emitted from the phosphor sheet, and
a detecting means which detects light guided by the heavy-element-containing light guide means.

3. A dosimetry system comprising a heavy-element-containing phosphor sheet which is formed by heavy-element-containing phosphors containing therein a heavy element to emit light in an amount corresponding to the dose of radiation irradiated thereto and is opposed to a radiation image recording medium, which is exposed to radiation passing through an object to record a radiation image of the object carried by the radiation, on the side opposite to the object,
a light guide means which transmits light emitted from the heavy-element-containing phosphor sheet, reflects the transmitted light by a reflecting portion provided for the whole or a part of the light exit face through which the light emitted from the heavy-element-containing phosphor sheet exits and guides the reflected light, and
a detecting means which detects light guided by the light guide means.

4. A dosimetry system comprising
a phosphor sheet which is formed by phosphors to emit light in an amount corresponding to the dose of radiation irradiated thereto and is opposed to a radiation image recording medium, which is exposed to radiation passing through an object to record a radiation image of the object carried by the radiation, on the side opposite to the object,
a heavy-element-containing light guide means which is formed by material containing therein a heavy element, transmits light emitted from the phosphor sheet, reflects the transmitted light by a reflecting portion provided for the whole or a part of the light exit face through which the light emitted from the phosphor sheet exits and guides the reflected light, and
a detecting means which detects light guided by the heavy-element-containing light guide means.
